(19) United States
(12) Patent Application Publication
(10) Pub. No.: US 2013/0155355 A1
(43) Pub. Date: Jun. 20, 2013

(54) FILTER UNIT OF LIQUID CRYSTAL DISPLAY AND LIQUID CRYSTAL DISPLAY

(71) Applicants: Chia-Hao Li, Taoyuan County (TW); Chen-Hsien Liao, Taipei City (TW); Kuei-Bai Chen, New Taipei City (TW); Chien-Kai Chen, Taipei City (TW)

(72) Inventors: Chia-Hao Li, Taoyuan County (TW); Chen-Hsien Liao, Taipei City (TW); Kuei-Bai Chen, New Taipei City (TW); Chien-Kai Chen, Taipei City (TW)

(73) Assignee: Au Optronics Corporation, Hsinchu (TW)

(21) Appl. No.: 13/450,439

(22) Filed: Apr. 18, 2012

(30) Foreign Application Priority Data
Dec. 20, 2011 (TW) 100147463

(51) Int. Cl. G02F 1/1335

(52) U.S. Cl. 349/106

(57) ABSTRACT

A filter unit of a LCD and a LCD are provided. Under a CIE standard C light source, an x-coordinate value of light passing through the filter unit in a CIE 1931 chromaticity coordinate is greater than or equal to 0.302, an illumination Y value of the light is greater than or equal to 60, and relative to the standard color sample in which (x, y) is (0.299, 0.595) in a CIE 1931 chromaticity coordinate, the CIE DE2000 color difference value ΔE₀₀ of the light is less than 1.

### CROSS-REFERENCE TO RELATED APPLICATION

This application claims the priority benefit of Taiwan application serial no. 100147463, filed on Dec. 20, 2011. The entirety of the above-mentioned patent application is hereby incorporated by reference herein and made a part of this specification.

### BACKGROUND OF THE INVENTION

1. Field of the Invention

The present invention generally relates to a filter unit of a liquid crystal display (LCD) and an LCD, in particular, to a filter unit having high light transmittance of an LCD and an LCD.

2. Description of Related Art

Liquid crystal displays (LCDs), with advantages such as high definition, small volume, light weight, low driving voltage, lower power consumption, and broad application range, have become the mainstream of the new generation display by replacing cathode ray tubes (CRTs). The LCD is mainly formed by a liquid crystal panel and a backlight module. Through a plane light source provided by the backlight module, grey-scale display may be performed after being controlled by the liquid crystal panel.

As for the color performance of the LCD, generally, colors are presented through color blending of light of backlight module by using the filter unit in the liquid crystal panel. For example, in a thin-film transistor LCD (TFT-LCD), a filter unit corresponding to each pixel is generally formed by red, green, and blue color resists, and the size of and space between the color resists is less than the size range recognizable by human eyes, so the LCD viewed by the human eyes may assume a colorful display blended by light of different colors (red light, green light, and blue light).

In order to enable the display to have desired display effect, the filter unit may have higher light transmittance by adjusting the material of the color resists. Therefore, how to select an appropriate material of the color resists to enable the filter unit to have higher light transmittance has become an important issue.

### SUMMARY OF THE INVENTION

Accordingly, the present invention is directed to a filter unit of an LCD, which has high light transmittance.

The present invention is further directed to an LCD, in which a filter unit has high light transmittance.

The present invention provides a filter unit of an LCD, where under a CIE standard C light source, an x-coordinate value of light passing through the filter unit in a CIE 1931 chromaticity coordinate is greater than or equal to 0.302, an illumination Y value of the light is greater than or equal to 60, and relative to a standard color sample in which (x, y) is (0.299, 0.595) in a CIE 1931 chromaticity coordinate, a CIE DE2000 color difference value ΔE₀₀ of the light is less than 1.

According to the filter unit of the LCD in the present invention, a thickness range of the filter unit is, for example, 1.97 microns≦the thickness of the filter unit≦2.27 microns.

According to the filter unit of the LCD in the present invention, the filter unit includes a filter layer and a transparent conductive layer covering the filter layer.

According to the filter unit of the LCD in the present invention, a thickness range of the filter layer is, for example, 1800 nanometers≦the thickness of the filter layer≦2150 nanometers.

According to the filter unit of the LCD ain the present invention, a thickness range of the transparent conductive layer is, for example, 100 nanometers≦the thickness of the transparent conductive layer≦150 nanometers.

The present invention further provides an LCD, which includes a backlight module and a liquid crystal panel. The liquid crystal panel is disposed above the backlight module. The liquid crystal panel has a filter unit, where under a CIE standard C light source, an x-coordinate value of light passing through the filter unit in a CIE 1931 chromaticity coordinate is greater than or equal to 0.302, an illumination Y value of the light is greater than or equal to 60, and relative to a standard color sample in which (x, y) is (0.299, 0.595) in a CIE 1931 chromaticity coordinate, a CIE DE2000 color difference value ΔE₀₀ of the light is less than 1.

According to the LCD in the present invention, a thickness range of the filter unit is, for example, 1.97 microns≦the thickness of the filter unit≦2.27 microns.

According to the LCD in the present invention, the filter unit includes a filter layer and a transparent conductive layer covering the filter layer.

According to the LCD in the present invention, a thickness range of the filter layer is, for example, 1800 nanometers≦the thickness of the filter layer≦2150 nanometers.

According to the LCD in the present invention, a thickness range of the transparent conductive layer is, for example, 100 nanometers≦the thickness of the transparent conductive layer≦150 nanometers.

In view of the above, as for the filter unit of the present invention, under a CIE standard C light source, an x-coordinate value of light passing through the filter unit in a CIE 1931 chromaticity coordinate is greater than or equal to 0.302, an illumination Y value of the light is greater than or equal to 60, and relative to a standard color sample in which (x, y) is (0.299, 0.595) in a CIE 1931 chromaticity coordinate, a CIE DE2000 color difference value ΔE₀₀ of the light is less than 1, so the filter unit of the present invention may have high light transmittance, and possess color difference that is invisible by human eyes. In other words, the present invention is capable of effectively improving the light transmittance of the filter unit in a color difference range that is invisible by human eyes, so that light passing through the filter unit can have higher illumination.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic sectional view of an LCD according to an embodiment of the present invention;

FIG. 2 is a CIE 1931 chromaticity coordinate diagram of light passing through the filter unit; and

FIG. 3 and FIG. 4 are relation diagrams of light transmittance and wavelength of samples.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

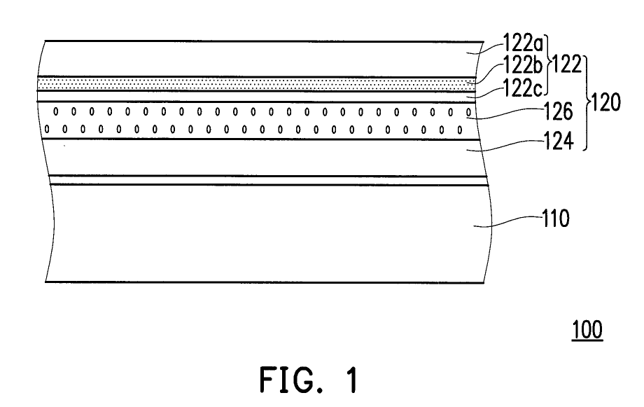

FIG. 1 is a schematic sectional view of an LCD according to an embodiment of the present invention. Referring to FIG. 1, an LCD 100 of this embodiment includes a backlight module 110 and a liquid crystal panel 120. The liquid crystal panel 120 is disposed above the backlight module 110. The liquid crystal panel 120 includes a filter substrate 122, a thin-film transistor (TFT) array substrate 124 and a liquid crystal layer 126. The liquid crystal layer 126 is disposed between the filter substrate 122 and the TFT array substrate 124. For clarity, in FIG. 1, detailed constructions of the backlight module 110 and the TFT array substrate 124 are not shown, the backlight module 110 and the TFT array substrate 124 are members well-known by persons skilled in the art, and are not illustrated herein.

Moreover, the filter substrate 122 includes a substrate 122a and a filter unit formed by a filter layer 122b and a transparent conductive layer 122c. The filter layer 122b is disposed above the substrate 122a. The transparent conductive layer 122c covers the filter layer 122b. A thickness range of the filter unit is, for example, 1.97 microns≦the thickness of the filter unit≦2.27 microns. A thickness range of the filter layer 122b is, for example, 1800 nanometers≦the thickness of the filter layer≦2150 nanometers. A thickness range of the transparent conductive layer 122c is, for example, 100 nanometers≦the thickness of the transparent conductive layer≦150 nanometers. The filter unit of this embodiment are illustrated in detail below, in which the illustration of the optical characteristics of the filter unit are made by using a CIE standard C light source as the backlight.

The filter unit of this embodiment is formed by the filter layer 122b and the transparent conductive layer 122c. The filter layer 122b is, for example, a green color resist, in which a yellow color resist is doped. That is to say, the filter layer 122b of this embodiment is a yellowish green filter layer, so as to improve the illumination of light after passing through the filter layer 122b. Specifically, under the CIE standard C light source, an x-coordinate value of light passing through the filter unit of this embodiment in a CIE 1931 chromaticity coordinate is greater than or equal to 0.302, an illumination Y value of the light is greater than or equal to 60, and relative to a standard color sample in which (x, y) is (0.299, 0.595) in a CIE 1931 chromaticity coordinate, a CIE DE2000 color difference value ΔE₀₀ of the light is less than 1. The ΔE₀₀ is less than 1, so under the same illumination, the human eyes cannot aware the shown color difference between the yellowish green filter layer 122b in this embodiment and a pure green filter layer.

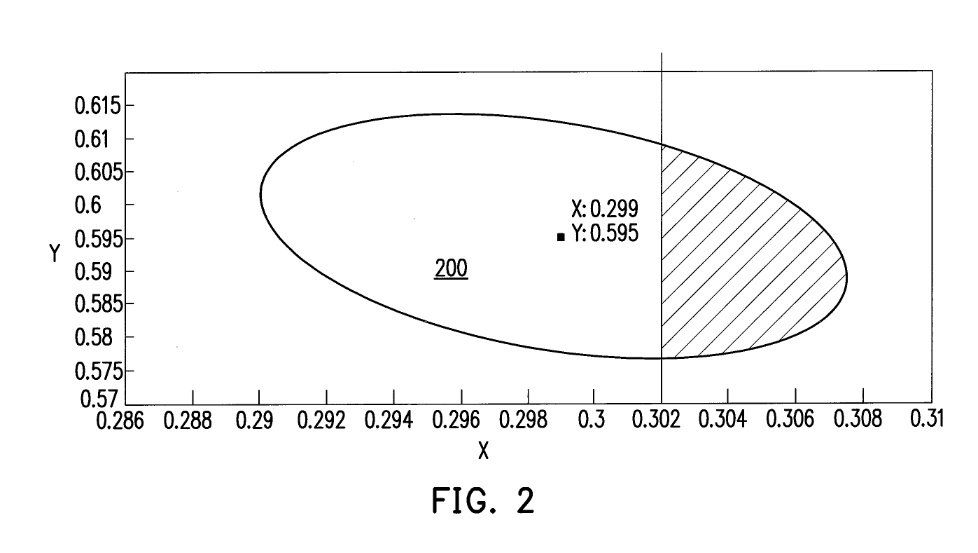

FIG. 2 is a CIE 1931 chromaticity coordinate diagram of light passing through the filter unit. Referring to FIG. 2, an area 200 in the drawing represents an area in which a CIE DE2000 color difference value ΔE₀₀ of the light is less than 1, and an oblique line area in the area 200 represents a chromaticity area after light passing through the filter unit in this embodiment (that is, an x-coordinate value is greater than 0.302, and the ΔE₀₀ is less than 1). In the oblique line area, measured illumination Y values are all greater than or equal to 60. That is to say, after the light passing through the filter unit of this embodiment, the filter unit of this embodiment has higher light transmittance, so the illumination of the light passing through the filter unit may be effectively improved (the illumination Y value are all greater than or equal to 60).

It should be noted that, the CIE standard C light source serving as the backlight is used to illustrate the optical characteristics of the filter unit of this embodiment; however, the filter unit of this embodiment may also be applicable to other backlight sources according to actual requirements.

The filter unit of the present invention is illustrated through Table 1 and Table 2, in which the illumination of the light after passing through the filter unit of a sample 1 is set as a standard value, and difference percentages of samples 2 and 3 with respect to the sample 1 can be obtained according to the standard value.

In the Table 1, CIE 1931 chromaticity coordinates, illumination Y values of the samples 1, 2, 3, and the illumination difference percentages of the samples 2, 3 with respect to the sample 1 are shown, where in the Table 1, results are obtained under a C light source. In the Table 2, CIE 1931 chromaticity coordinates, illumination Y values of the samples 1, 2, 3, and the illumination difference percentages of the samples 2, 3 with respect to the sample 1 after the samples 2, 3 are adjusted to become the filter units of the present invention (having the optical characteristics that: under a CIE standard C light source, an x-coordinate value of light passing through the filter unit in a CIE 1931 chromaticity coordinate is greater than or equal to 0.302, an illumination Y value of the light is greater than or equal to 60, and relative to a standard color sample in which (x, y) is (0.299, 0.595) in a CIE 1931chromaticity coordinate, a CIE DE2000 color difference value ΔE₀₀ of the light is less than 1), where in the Table 2, results are obtained under a C light source.

TABLE 1

| | X-coordinate | Y-coordinate | Illumination Y | | |
|---|---|---|---|---|---|
| Sample | value | value | value | ΔY | Δ E₀₀ |
| 1 | 0.302 | 0.595 | 58.36 | — | |
| 2 | 0.301 | 0.594 | 59.83 | 2.51% | 0.056 |
| 3 | 0.306 | 0.596 | 61.74 | 5.79% | 0.588 |

TABLE 2

| | X-coordinate | Y-coordinate | Illumination Y | | |
|---|---|---|---|---|---|
| sample | value | value | value | ΔY | Δ E₀₀ |
| 1 | 0.302 | 0.595 | 58.36 | — | |
| 2 | 0.307 | 0.585 | 61.58 | 5.52% | 0.82 |
| 3 | 0.307 | 0.591 | 62.60 | 7.26% | 0.76 |

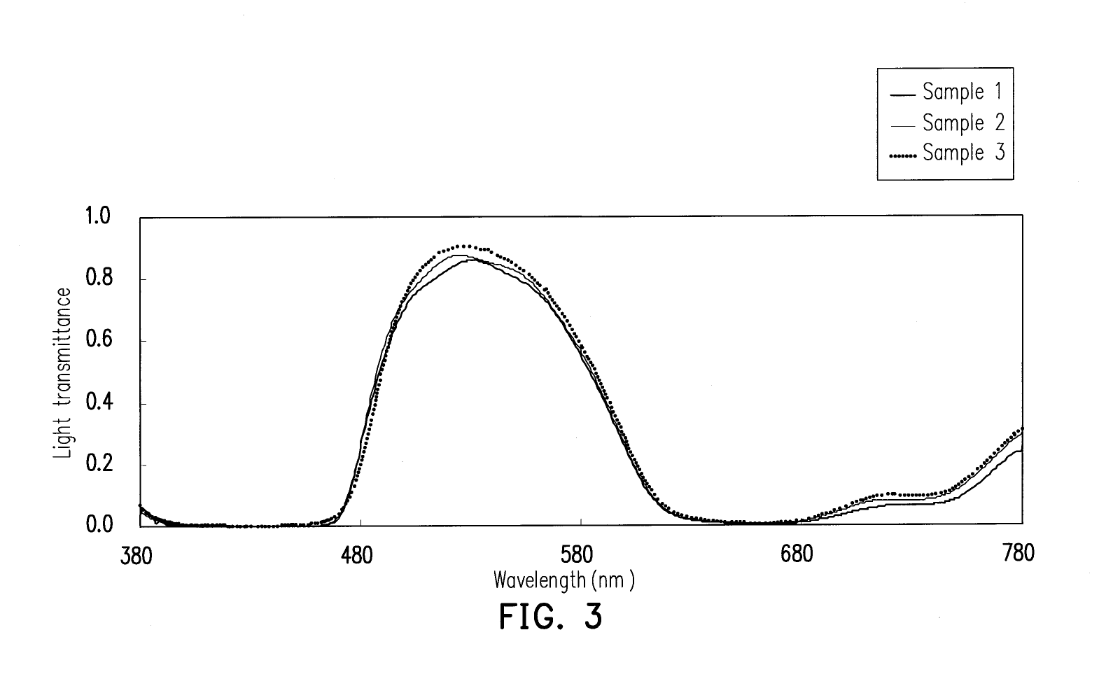

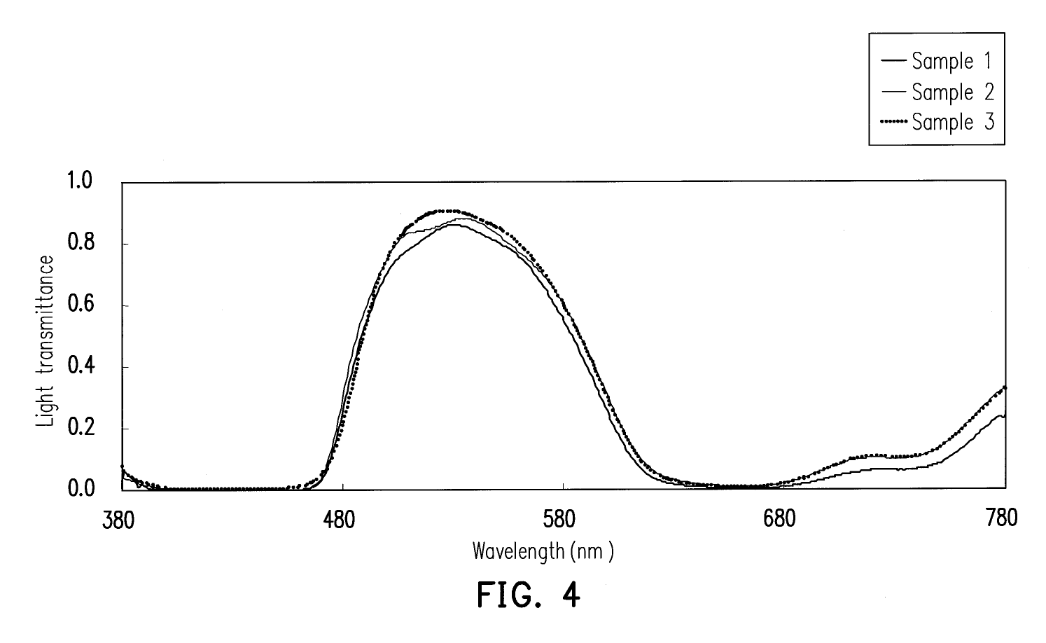

It can be clearly seen from Table 1, Table 2, FIG. 3 and FIG. 4 that, after the sample 2 and the sample 3 are adjusted to become the filter units of the present invention (having the optical characteristics that: under a CIE standard C light source, an x-coordinate value of light passing through the filter unit in a CIE 1931 chromaticity coordinate is greater than or equal to 0.302, an illumination Y value of the light is greater than or equal to 60, and relative to a standard color sample in which (x, y) is (0.299, 0.595) in a CIE 1931chromaticity coordinate, a CIE DE2000 color difference value ΔE₀₀ of the light is less than 1), the light transmittance may be improved effectively, so that the light passing through the samples 2, 3 have higher illumination. Moreover, the ΔE₀₀ of the samples 2, 3 is less than 1, so the human eyes cannot recognize the shown color difference between the samples 2, 3 (the yellowish green filter layers) and a pure green filter layer.

The “adjustment” mentioned above refers to adjusting the filter layer to be yellowish green (having a color difference value ΔE₀₀ less than 1) while keeping the thickness of the transparent conductive layer and the thickness of the filter layer unchanged, so that the light passing through the filter unit has higher illumination.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A filter unit of a liquid crystal display (LCD), wherein under a CIE standard C light source, an x-coordinate value of light passing through the filter unit in a CIE 1931 chromaticity coordinate is greater than or equal to 0.302, an illumination Y value of the light is greater than or equal to 60, and relative to a standard color sample in which (x, y) is (0.299, 0.595) in a CIE 1931 chromaticity coordinate, a CIE DE2000 color difference value ΔE₀₀ of the light is less than 1.

2. The filter unit of an LCD according to claim 1, wherein a thickness range of the filter unit is 1.97 microns≦the thickness of the filter unit 2.27 microns.

3. The filter unit of an LCD according to claim 1, comprising:
a filter layer; and
a transparent conductive layer, covering the filter layer.

4. The filter unit of an LCD according to claim 3, wherein a thickness range of the filter layer is 1800 nanometers≦the thickness of the filter layer≦2150 nanometers.

5. The filter unit of an LCD according to claim 3, wherein a thickness range of the transparent conductive layer is 100 nanometers≦the thickness of the transparent conductive layer≦150 nanometers.

6. A liquid crystal display (LCD), comprising:
a backlight module; and
a liquid crystal panel, disposed above the backlight module, the liquid crystal panel has a filter unit, wherein under a CIE standard C light source, an x-coordinate value of light passing through the filter unit in a CIE 1931 chromaticity coordinate is greater than or equal to 0.302, an illumination Y value of the light is greater than or equal to 60, and relative to a standard color sample in which (x, y) is (0.299, 0.595) in a CIE 1931 chromaticity coordinate, a CIE DE2000 color difference value ΔE₀₀ of the light is less than 1.

7. The LCD according to claim 6, wherein a thickness range of the filter unit is 1.97 microns≦the thickness of the filter unit≦2.27 microns.

8. The LCD according to claim 6, wherein the filter unit comprises:
a filter layer; and
a transparent conductive layer, covering the filter layer.

9. The LCD according to claim 8, wherein a thickness range of the filter layer is 1800 nanometers≦the thickness of the filter layer≦2150 nanometers.

10. The LCD according to claim 8, wherein a thickness range of the transparent conductive layer is 100 nanometers≦the thickness of the transparent conductive layer≦150 nanometers.
